(19) United States
(12) Patent Application Publication
(10) Pub. No.: US 2022/0379813 A1
(43) Pub. Date: Dec. 1, 2022

(54) Drinking Straw Storage Device

(71) Applicants: Stephen Volodymyr Oryst Pidzamecky, Guelph (CA); Heather Laura Pidzamecky, Guelph (CA)

(72) Inventors: Stephen Volodymyr Oryst Pidzamecky, Guelph (CA); Heather Laura Pidzamecky, Guelph (CA)

(21) Appl. No.: 17/334,904

(22) Filed: May 31, 2021

(51) Int. Cl. B60R 7/08; A47G 19/30; B60R 7/05

(52) U.S. Cl. CPC B60R 7/08; A47G 21/184; B60R 7/05; B60R 2011/0035

(57) ABSTRACT

A device includes a body, at least one compartment for storing a plurality of straws, and at least one fastener for fastening the device to a surface. Preferably, the at least one fastener is a sun visor clip for fastening the device to a vehicle sun visor. In this version, the device is particularly useful for drive-thru customers to be able to store reusable straws nearby so that they do not have to use a disposable plastic straw.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of drinking straws of existing art and more specifically relates to a storage device for drinking straws.

### RELATED ART

A drinking straw is a utensil used in effectively transporting a beverage to one's mouth via suction. Drinking straws have been used for thousands of years and have grown to be expected in beverages, particularly beverages from drive-thru restaurants. These drinking straws are typically made from plastic and are made to be disposed of after use.

Environmental concerns due this source of pollution have resulted in new laws and regulations in many countries to reduce the usage of single-use plastics. Due to this, there has been a rise in the use of reusable straws. Reusable straws are typically made from durable plastic, glass, or stainless steel. However, a problem with reusable straws is that it is easy for an individual to forget to bring their reusable straws into their car, and if the individual does remember, there is currently no satisfactory storage solution. Thus, a suitable solution is desired.

### SUMMARY OF THE INVENTION

In view of the foregoing disadvantages inherent in the known drinking straw holder art, the present disclosure provides a novel drinking straw storage device. The general purpose of the present disclosure, which will be described subsequently in greater detail, is to provide a device for removably storing at least one straw. The device may be further be configured for removable attachment to a surface.

A device for removably storing at least one straw is disclosed herein. The device includes a body, at least one compartment and at least one fastener. The body may include a front side and a rear side relative to the surface. The at least one compartment may be integral to the body and may be sized to removably receive and retain the at least one straw. The at least one fastener may be attached to the rear side of the body. The at least one fastener may be configured to attach the device to the surface.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a drinking straw storage device, constructed and operative according to the teachings of the present disclosure.

FIG. 1 is a perspective view of a device, during an ‘in-use’ condition, according to an embodiment of the disclosure.

FIG. 2 is a side perspective view of the device, illustrating the device storing a plurality of straws, according to an embodiment of the present disclosure.

FIG. 3 is a side view of the device of FIG. 2, illustrating a slot-diameter of a plurality of slots in relation to a straw-diameter of a straw, according to an embodiment of the present disclosure.

FIG. 4 is a front view of the device, illustrating the device storing the plurality of straws according to another embodiment of the present disclosure.

FIG. 5 is a side perspective view of the device of FIG. 4, according to another embodiment of the present disclosure.

FIG. 6 is a side perspective view of the device, illustrating the device storing the plurality of straws according to another embodiment of the present disclosure.

FIG. 7 is a front view of the device of FIG. 6, illustrating a straw being placed into the device, according to an embodiment of the present disclosure.

FIG. 8 is a side perspective view of the device of FIG. 1, illustrating a rear of the device including a sun visor clip for attaching the device to a vehicle sun visor, according to an embodiment of the present disclosure.

FIG. 9A is a side view of the device of FIG. 7, illustrating the device being attached to the vehicle sun visor via the sun visor clip, according to an embodiment of the present disclosure.

FIG. 9B is a side view of the device of FIG. 8A, illustrating the sun visor clip not attached to the vehicle sun visor, according to an embodiment of the present disclosure.

FIG. 10 is a perspective view of a kit, illustrating the device and the plurality of straws, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a drinking straw holder and more particularly to a drinking straw storage device. Generally disclosed is a straw storage mechanism which may be suitable for standard size and thickness reusable straws. The straw storage mechanism may be particularly useful for drive-thru customers to be able to store reusable straws nearby so that they don't have to use a disposable plastic straw. In some embodiments, the straw storage mechanism may be configured for storing 3-5 straws made of various materials and including various lengths.

The straw storage mechanism may include a front-facing area and a rear area. The front-facing area may provide some simple user-labels. For example, one direction of the straw storage mechanism could indicate “clean” straws and another direction may indicate “used” straws. Additionally, the front-facing area may be include logos, branding, indicia, and/or labels. The straw storage mechanism may include a “slide-in” embodiment whereby each straw is slid into openings; a “pop-in” embodiment whereby each straw is “pushed” into a slot which holds the straw in place; and/or a “cartridge” embodiment whereby straws are loaded into a spring-mechanism that slides further and further as more straws are added.

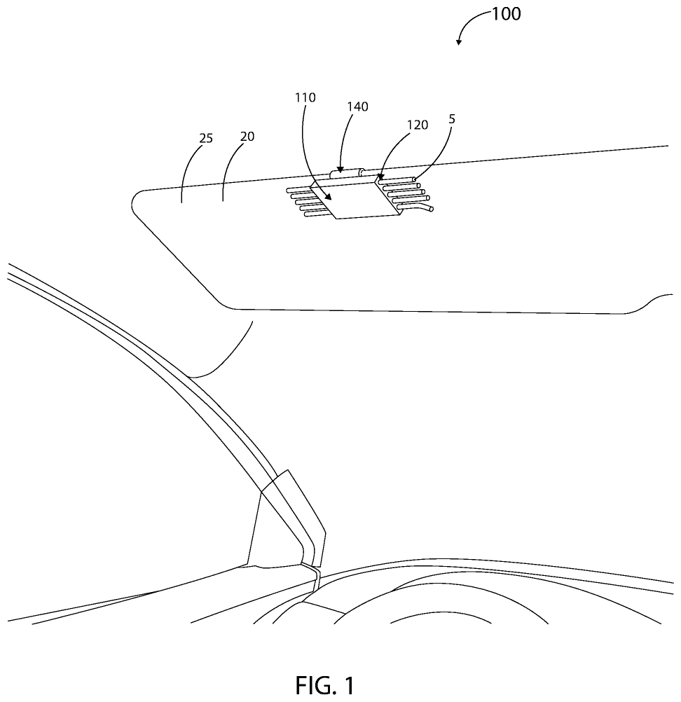

Referring now more specifically to the drawings by numerals of reference, there is shown in FIGS. 1-10, various views of a device 100 for removably storing at least one straw (“device” 100).

FIG. 1 illustrates an example configuration of the device 100 in-use, according to one embodiment of the present disclosure. As shown, the device 100 may be used for removably storing at least one straw 5. Further, as shown, the device 100 may be configured for removable attachment to a surface 20. Preferably, the surface 20 may be a vehicle sun visor 25. The device 100 may be configured to attach to the vehicle sun visor 25, providing a user with easy access to a straw 5 when in their vehicle. Particularly, this device 100 may be useful for drive-thru restaurants. As shown, the device 100 may include a body 110, at least one compartment 120 and at least one fastener 140.

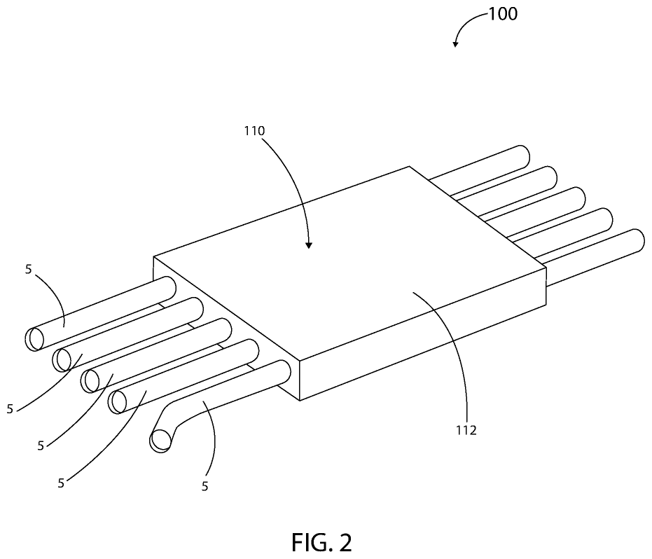

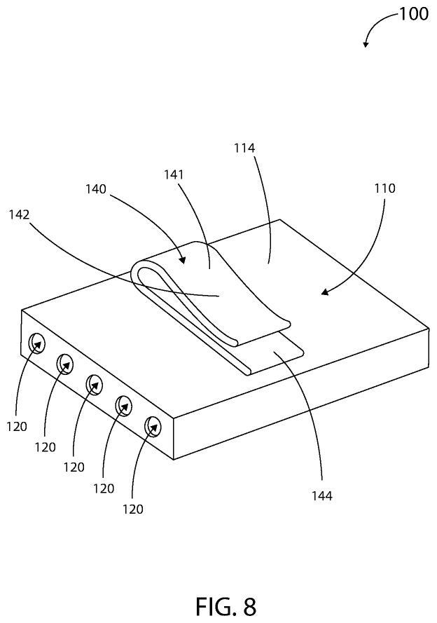

The device 100 may include a body 110 that includes at least a front side 112 (FIG. 2) and a rear side 114 (FIG. 8) relative to the surface 20. The body 110 may be made from a sturdy and durable yet lightweight material such as plastic. Other materials contemplated may include metal, silicone, etc. The front side 112 of the body 110 may include indicia such as decorative, functional and/or branding indicia. For example, in some embodiments, the front side 112 of the body 110 may include functional indicia for indicating a “clean” side of the body 110 and a “used” side of the body 110 (thus indicating which straw(s) 5 are clean and which are used and need to be cleaned). Other decorative features may also be included such as logos, patterns, colors, etc.

The at least one compartment 120 may be integral to the body 110 and may be sized to removably receive the at least one straw 5. In some embodiments, the at least one compartment 120 may be defined by at least one slot 122. Preferably, as shown in FIGS. 1-5, the at least one compartment 120 may include a plurality of slots 122 and each slot 122 may be configured to receive and retain one straw 5 in a substantially parallel orientation to each other, or the like. For example, in some embodiments, the plurality of slots 122 may include five slots, and as such, the device 100 may be configured to receive and retain five straws 5 (one in each slot 122).

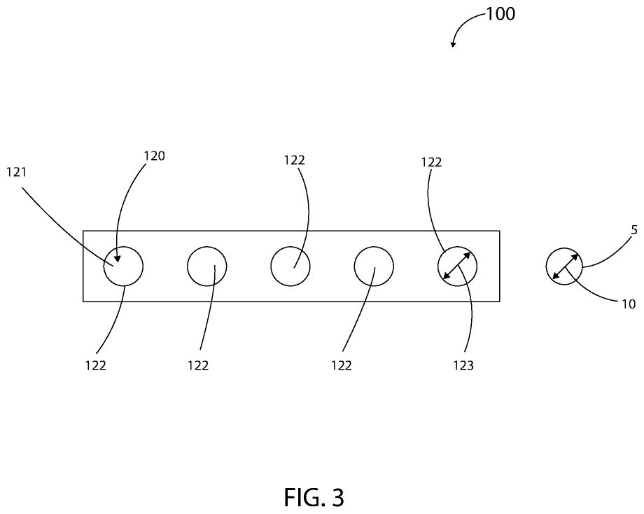

In one embodiment of the present disclosure, as illustrated specifically in FIGS. 2-3, the at least one slot 122 may include a hollow elongated cylindrical profile 121 configured to accommodate a straw-profile of the at least one straw 5. As shown in FIG. 2, in some embodiments, the elongated cylindrical profile 121 of the at least one slot 122 may be substantially horizontal relative to the surface 20. As such, the at least straw 5 may be stored substantially horizontally relative to the surface 20. However, other configurations may be contemplated. For example, the elongated cylindrical profile 121 of the at least one slot 122 may be substantially vertical relative to the surface 20 (and thus may store the at least one straw 5 vertically relative to the surface 20).

The at least one slot 122 may be configured to slidably receive the at least one straw 5. To facilitate this, the at least one slot 122 may include a first opening and a second opening providing access to the at least slot 122. The at least one straw 5 may be slid into the at least one slot 122 via either of the first opening or the second opening. In other embodiments, the at least one slot 122 may include only one opening for providing access to the at least one slot 122.

The at least one compartment 120 may include a retainer means 130 configured to removably retain the at least one straw 5 in the at least one compartment 120. In the embodiment discussed above (wherein the at least one straw 5 is slidably inserted into the at least one slot 122), the retainer means 130 may include at least a portion of a slot-diameter 123 of the at least one slot 122 being substantially equal to a straw-diameter 10 of the at least one straw 5, thereby holding the at least one straw 5 in the at least one slot 122 via friction.

In some embodiments, the portion of the slot-diameter 123 may be tapered. In this example, the slot-diameter 123 may be generally equal to or larger than the straw-diameter 10 and may taper to a lesser diameter such that when a user slides the at least one straw 5 into the at least one slot 122 and it reaches the portion, it is held in friction within the at least one slot 122. In other embodiments, the at least one straw 5 may be retained within the at least one slot 122 via a shape of the at least one straw 5. For example, the at least one straw 5 may include an angled top, thereby effectively preventing the at least one straw 5 from falling through the at least one slot 122.

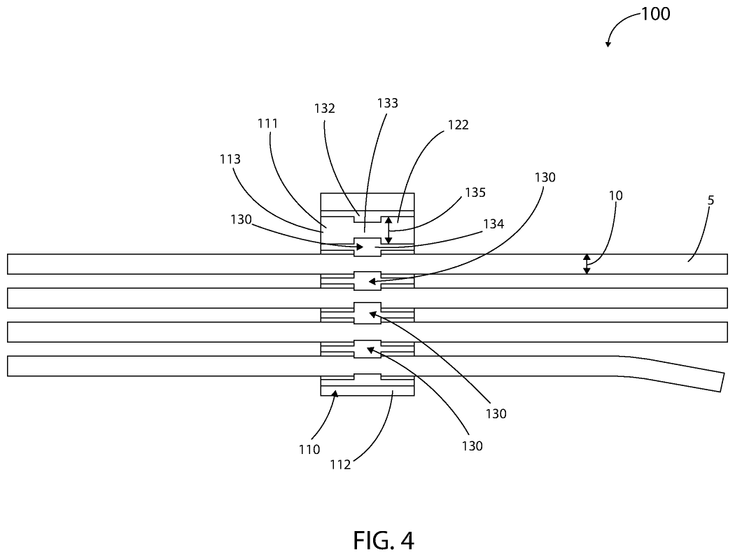

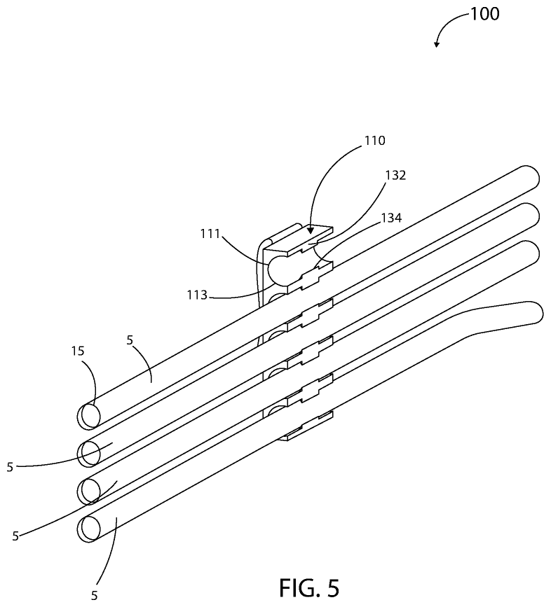

In another embodiment of the present disclosure, as illustrated in FIGS. 4-5, the at least one slot 122 may be defined by a section 111 of the body 110 including a concave curvature 113, and the concave curvature 113 may be configured to accommodate a straw-curvature 15 of the at least one straw 5. For example, as shown, the at least one slot 122 may include a substantially arcuate configuration. Further, as above and as shown, preferably, the at least one slot 122 may be a plurality of slots 122. Again, the plurality of slots 122 may include five slots (but is not limited to this amount). In this embodiment, the at least one straw 5 may be “pushed” into the at least one slot 122.

In this embodiment, the retainer means 130 may include a first clip-half 132 attached about a left side 125 of the at least one slot 122 and a second clip-half 134 attached about a right side 126 of the at least one slot 122. In some embodiments, the first clip-half 132 may be attached about a left top/front side of the at least one slot 122 (relative to the surface 20) and the second clip-half 134 may be attached about right top/front side of the at least one slot 122 (again, relative to the surface 20). The first clip-half 132 and the second clip-half 134 may define a clip-opening 133 (within the substantially arcuate configuration of the at least one slot 122). The opening-width 135 may include an opening-width 135 smaller than the straw-diameter 10 of the at least one straw 5 when the first clip-half 132 and the second clip-half 134 are in a retaining position (retaining at least one straw 5 within the at least one slot 122), or when not in use.

The first clip-half 132 and the second clip-half 134 may be configured to “deform” outwardly when downward pressure is applied (when the at least one straw 5 is pushed into the at least one slot 122). This downward pressure thereby may temporarily effectively widen the opening-width 135 of the clip-opening 133 and place the first clip-half 132 and the second clip-half 134 into an accepting position, with the accepting position allowing insertion of the at least one straw 5 into the at least one slot 122. Upon insertion of the at least one straw 5 into the at least one slot 122, the first clip-half 132 and the second clip-half 134 may be configured to “spring” back into the retaining position whereby the opening-width 135 is smaller than the straw-diameter 10 of the at least one straw 5. The retaining position may thus retain the at least one straw 5 in the at least one slot 122 via friction.

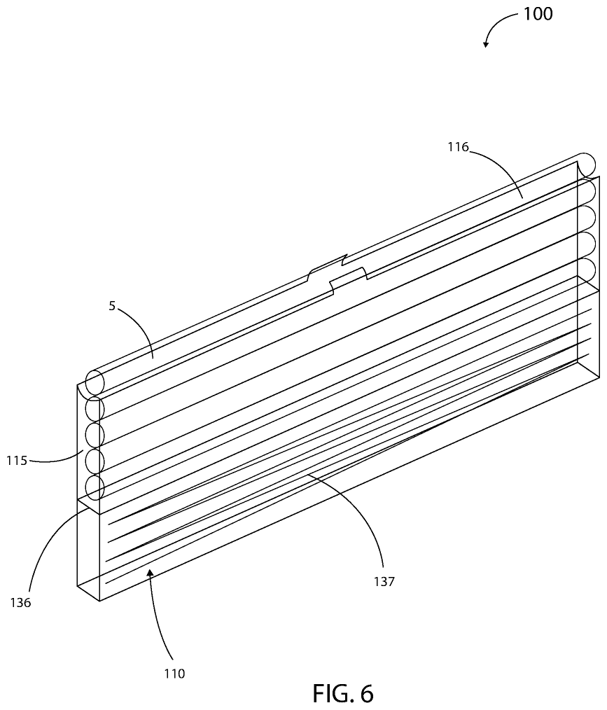

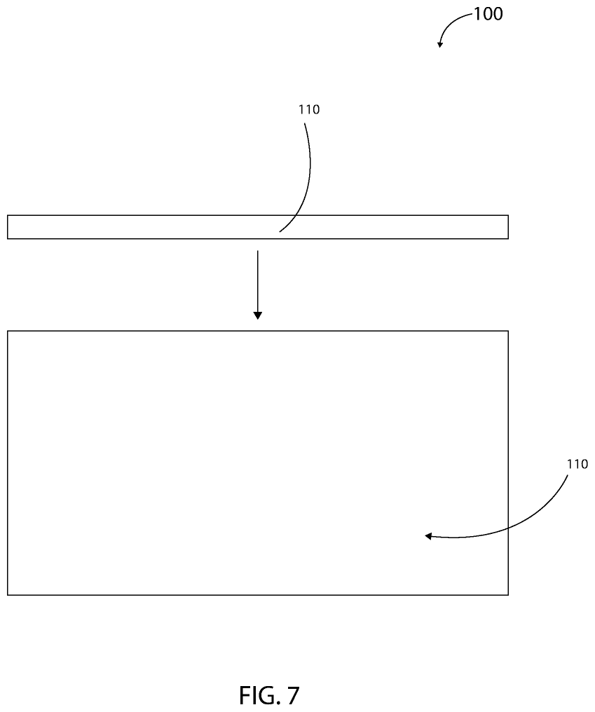

In another embodiment of the present disclosure, as illustrated in FIGS. 6-7, the body 110 may include an inner capacity 115 and a body-opening 116 providing access to the inner capacity 115. The at least one compartment 120 may be integral to the inner capacity 115 of the body 110 and may be sized to receive and retain the plurality of straws 5. For example, in this embodiment, the at least one compartment 120 may be size to receive and retain five straws. In FIG. 6, the device 100 is shown to be transparent to illustrate the plurality of straws 5 and inner mechanisms of the body 110 within the inner capacity 115 thereof.

In this embodiment, the retainer means 130 may include a platform 136 and a spring 137 located in the at least one compartment 120. The spring 137 may be attached to one side of the platform 136 and each of the plurality of straws 5 may be loaded via the body-opening 116 at another side of the platform. The spring 137 may be configured to be compressed by the plurality of straws 5 (the spring 137 compressing further the more straws 5 added), thereby holding the plurality of straws 5 in (spring) tension.

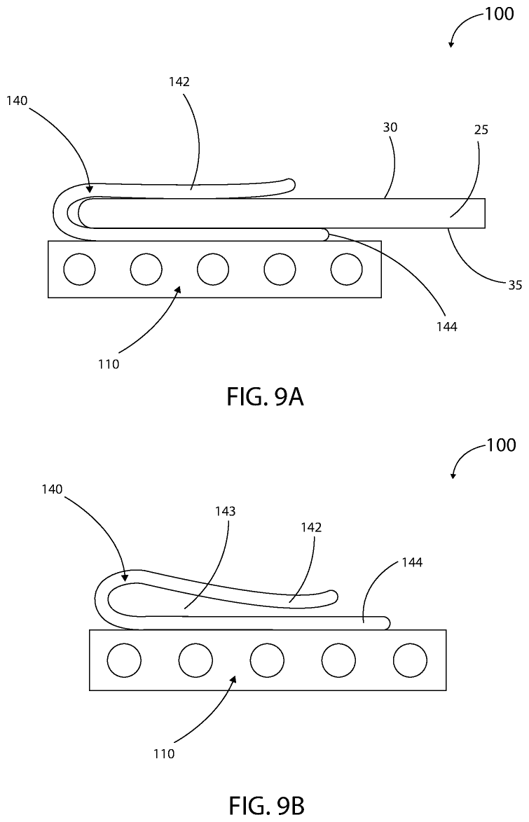

As shown in FIGS. 8-9B, the at least one fastener 140 may be attached to the rear side 114 of the body 110 and may be configured to attach the device 100 to the surface 20. As above and as illustrated, preferably, the surface 20 may be the vehicle sun visor 25. As such, the at least one fastener 140 may include a sun visor clip 141. In some embodiments, as shown in FIGS. 8-9B, the sun visor clip 141 may be defined by a first leg 142 and a second leg 144. The second leg 144 may be attached to the rear side 114 of the body 110 and the first leg 142 and the second leg 144 may define a clamp-opening 143 therebetween. The clamp-opening 143 may be configured to receive the vehicle sun visor 25 and the first leg 142 and the second leg 144 may be configured to hold the vehicle sun visor 25.

In some embodiments, the vehicle sun visor 25 may be held via friction by the first leg 142 and the second leg 144. For example, the vehicle sun visor 25 may be slid into the clamp-opening 143, and the first leg 142 may press against a first side 30 of the vehicle sun visor 25 and the second leg 144 may press against a second side 35 of the vehicle sun visor 25. In this embodiment, the first leg 142 and the second leg 144 may be configured to deform outwardly to temporarily widen the clamp-opening 143 for receiving the vehicle sun visor 25. The first leg 142 and the second leg 144 may then “spring” back to firmly hold the vehicle sun visor 25, thus securely fastening the device 100 to the vehicle sun visor 25.

In other embodiments, the first leg 142 and the second leg 144 may be hingedly attached together at top ends thereof. Further, the top ends may define graspable handles for the first leg 142 and the second leg 144 and may include a clamp-spring. The clamp-spring may be hold the first leg 142 and the second leg 144 in a clamped position. The user may squeeze the graspable handles to place the first leg 142 and the second leg 144 in an open position. The clamp-spring may be biased towards the clamped position such that when the user releases their grip on the graspable handles, the first leg 142 and the second leg 144 may be placed into the clamped position (thereby securing the device 100 to the vehicle sun visor 25).

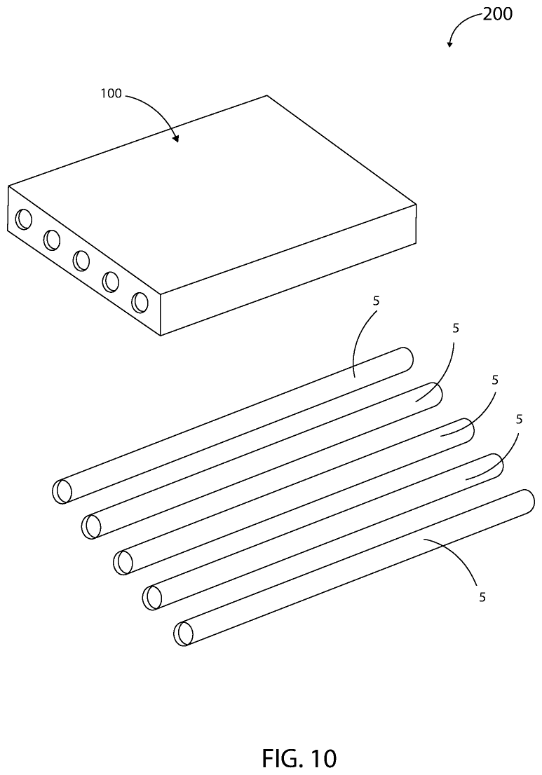

As above, the device 100 may be used for storing the plurality of straws 5. As such, as shown in FIG. 10, some embodiments of the present disclosure may comprise a kit 200. The kit 200 may include the device 100 (and any/all embodiments thereof discussed above) and the plurality of straws 5 for use with the device. The plurality of straws 5 may be standard sized straws. The plurality of straws 5 may be reusable. In this embodiment, the plurality of straws 5 may be made from washable materials such as stainless steel, durable plastic, glass, etc. In other embodiments, the plurality of straws 5 may be disposable. It is also contemplated that the device 100 may be configured for use with any standard straw 5.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for removably storing at least one straw, the device being configured for removable attachment to a surface, the device comprising:
a body including a front side and a rear side relative to the surface;
at least one compartment being integral to the body, the at least one compartment being sized to removably receive and retain the at least one straw; and
at least one fastener attached to the rear side of the body, the at least one fastener being configured to attach the device to the surface.

2. The device of claim 1, wherein the at least one compartment includes a retainer means configured to removably retain the at least one straw in the at least one compartment.

3. The device of claim 2, wherein the at least one compartment is defined by at least one slot.

4. The device of claim 3, wherein the at least one slot includes a hollow elongated cylindrical profile configured to accommodate a straw-profile of the at least one straw.

5. The device of claim 4, wherein the retainer means includes at least a portion of a slot-diameter of the at least one slot being substantially equal to a straw-diameter of the at least one straw, thereby holding the at least one straw in the at least one slot via friction.

6. The device of claim 5, wherein the at least one slot is configured to slidably receive the at least one straw.

7. The device of claim 1, wherein the at least one slot is defined by a section of the body including a concave curvature, the concave curvature configured to accommodate a straw-curvature of the at least one straw.

8. The device of claim 7, wherein the retainer means includes a first clip-half attached about a left side of the at least one slot and a second clip-half attached about a right side of the at least one slot, wherein the first clip-half and the second clip-half define an opening, and wherein the opening includes an opening-width smaller than the straw-diameter of the at least one straw when the first clip-half and the second clip-half are in a retaining position

9. The device of claim 8, wherein the first clip-half and the second clip-half are configured to deform outwardly when downward pressure is applied thereto thereby temporarily effectively widening the opening-width of the opening and placing the first clip-half and the second clip-half in an accepting position, the accepting position allowing insertion of the at least one straw into the at least slot.

10. The device of claim 9, wherein upon insertion of the at least one straw into the at least one slot, the first clip-half and the second clip-half are configured to spring back into the retaining position whereby the opening-width is smaller than the straw-diameter of the at least one straw, the retaining position thus retaining the at least one straw in the at least one slot via friction.

11. The device of claim 1, wherein the at least one compartment includes a plurality of slots, each slot being configured to receive and retain one straw.

12. The device of claim 1, wherein the body includes an inner capacity and a body-opening providing access to the inner capacity, wherein the at least one compartment is integral to the inner capacity of the body and wherein the at least one compartment is sized to receive and retain a plurality of straws.

13. The device of claim 12, wherein the retainer means includes a platform and a spring located in the at least one compartment, the spring being attached to one side of the platform, wherein each of the plurality of straws are loaded via the body-opening at another side of the platform, and wherein the spring is configured to be compressed by the plurality of straws, thereby holding the plurality of straws in tension.

14. The device of claim 1, wherein the surface is a vehicle sun visor, and wherein the at least one fastener includes a sun visor clip.

15. The device of claim 14, wherein the sun visor clip is defined by a first leg and a second leg, the second leg being attached to the rear side of the body, the first leg and the second leg forming a clamp-opening therebetween, the clamp-opening configured to receive the vehicle sun visor, the first leg and the second leg configured to hold the vehicle sun visor.

16. The device of claim 1, further comprising a kit, wherein the kit includes the device and a plurality of straws for use with the device.

17. A device for removably storing at least one straw, the device being configured for removable attachment to a vehicle sun visor, the device comprising:
a body including a front side and a rear side relative to the vehicle sun visor;
at least one compartment being integral to the body, the at least one compartment being sized to slidably receive and retain the at least one straw, the at least one compartment being defined by at least one slot, the at least one slot including an elongated cylindrical profile configured to accommodate a straw-profile of the at least one straw; and
a sun visor clip attached to the rear side of the body, the sun visor clip defined by a first leg and a second leg, the second leg being attached to the rear side of the body, the first leg and the second leg forming the clamp-opening therebetween, the clamp-opening configured to receive the vehicle sun visor, the first leg and the second leg configured to hold the vehicle sun visor.

18. The device of claim 17, wherein the at least one compartment includes a plurality of slots, each slot being configured to receive and retain one straw, and wherein the device is configured for removably storing a plurality of straws in parallel.

19. A device for removably storing at least one straw, the device being configured for removable attachment to a vehicle sun visor, the device comprising:
a body including a front side and a rear side relative to the vehicle sun visor;
at least one compartment being integral to the body, the at least one compartment being sized to receive the at least one straw, the at least one compartment including a retainer means configured to removably retain the at least one straw in the at least one compartment, the at least one compartment being defined by at least one slot, the at least one slot being defined by a section of the body including a concave curvature, the concave curvature configured to accommodate a straw-curvature of the at least one straw, the retainer means includes a first clip-half attached about a left side of the at least one slot and a second clip-half attached about a right side of the at least one slot, wherein the first clip-half and the second clip-half define an opening, and wherein the opening includes an opening-width smaller than the straw-diameter of the at least one straw when the first clip-half and the second clip-half are in a retaining position, the first clip-half and the second clip-half configured to deform outwardly when downward pressure is applied thereto thereby temporarily widening the opening-width of the opening and placing the first clip-half and the second clip-half in an accepting position, the accepting position allowing insertion of the at least one straw into the at least slot, and wherein upon insertion of the at least one straw into the at least one slot, the first clip-half and the second clip-half are configured to spring back into the retaining position whereby the opening-width is smaller than the straw-diameter of the at least one straw, the retaining position thus retaining the at least one straw in the at least one slot via friction; and
a sun visor clip attached to the rear side of the body, the sun visor clip defined by a first leg and a second leg, the second leg being attached to the rear side of the body, the first leg and the second leg forming a clamp-opening therebetween, the clamp-opening configured to receive the vehicle sun visor, the first leg and the second leg configured to hold the vehicle sun visor via friction.

20. The device of claim 19, wherein the at least one compartment includes a plurality of slots, each slot being configured to receive and retain one straw, and wherein the device is configured for removably storing a plurality of straws.
